(19) United States
(12) Patent Application Publication
(10) Pub. No.: US 2025/0219181 A1
(43) Pub. Date: Jul. 3, 2025

(54) SELECTIVE RECOVERY OF LITHIUM FROM TERNARY CATHODE ACTIVE MATERIAL OF SPENT LITHIUM ION BATTERIES

(71) Applicant: COSMOCHEMICAL CO., LTD., Seoul (KR)

(72) Inventors: EUIHYUK KWON, Incheon (KR); YU JIN LIM, Ulsan (KR); YUJIN PARK, Ulsan (KR)

(21) Appl. No.: 18/977,166

(22) Filed: Dec. 11, 2024

(30) Foreign Application Priority Data
Dec. 29, 2023 (KR) 10-2023-0196054

(51) Int. Cl. H01M 10/54; C22B 3/00; C22B 5/00; C22B 7/00; C22B 26/12; C22B 47/00

(52) U.S. Cl. CPC H01M 10/54; C22B 5/00; C22B 7/007; C22B 23/0415; C22B 26/12; C22B 47/00

(57) ABSTRACT

A method of recovering ternary valuable metals from a waste cathode active material includes a step of leaching valid metals in a waste cathode active material powder under acidic conditions, and a step of recovering the leached valid metals, wherein, in the step of leaching valid metals in the waste cathode active material powder under acidic conditions, an oxidizing agent is further added to selectively leach lithium. The method further comprises a step of leaching cobalt (Co) and nickel (Ni) from a residue separated from the lithium leachate leached by the step of leaching valid metals in the waste cathode active material powder under acidic conditions and recovering manganese dioxide (MnO₂) as a residue, a step of reducing the residue manganese dioxide, and a step of leaching the manganese dioxide.

### CROSS-REFERENCE TO RELATED APPLICATION

This application claims priority to and the benefit of Korean Patent Application No. 10-2023-0196054, filed on Dec. 29, 2023, the disclosure of which is incorporated herein by reference in its entirety.

### BACKGROUND

### 1. Field of the Invention

The present invention relates to a method for selectively recovering lithium from a waste ternary cathode active material, and more specifically, to a method for selectively leaching and removing lithium (Li) from a waste cathode active material powder of spent lithium ion batteries, containing nickel (Ni), cobalt (Co), manganese (Mn), and lithium (Li), thereby easily separating and recovering cobalt, nickel, and manganese contained in the residue.

### 2. Discussion of Related Art

Lithium secondary batteries are key components of electric vehicles and energy storage systems (ESS), and their demand is rapidly increasing as the supply of new and renewable energy without environmental pollution is increasing. As the demand for electric vehicle batteries increases, the production of lithium ion battery (LIB) cathode active materials of the nickel (Ni)-cobalt (Co)-manganese (Mn) (NCM) system is also increasing.

Accordingly, the ternary cathode active materials of lithium secondary batteries generated from electric vehicles, ESSs, and the like that have reached the end of their lifetime contain expensive valuable metals such as lithium (Li), cobalt (Co), and nickel (Ni), and there is a need for the development of an effective and economical process to recover these valuable metals and recycle them as raw materials for lithium secondary batteries.

Conventionally, to recover valuable metals from waste cathode active materials, LIB scrap is leached in an acidic solution, and a phased recovery process including manganese recovery, cobalt recovery, nickel recovery, and lithium recovery is carried out to recover valuable metals such as manganese, cobalt, nickel, and lithium.

However, this has the problem that the lithium removal is the final step, so the loss rate of lithium is high, and the manufacturing cost increases due to the process of recovering each valuable metal with high purity.

In addition, conventionally, waste cathode active materials are leached by non-selective dissolution, and then the valuable metals are recovered through the steps of impurity removal, NCM coprecipitation for removing Li, and sulfuric acid re-dissolution. However, since lithium removal is the final step, the loss rate of lithium is high, and additional processes such as sulfuric acid re-dissolution and impurity removal are required to recover NCM coprecipitates, which has caused the problem of low economic feasibility.

In addition, conventionally, to selectively recover only lithium from waste cathode active materials, a dry (reduction heat treatment)-wet (water leaching) phase process is used in which a dry reduction heat treatment is performed at 600° C. or higher with hydrogen, activated carbon, Na₂CO₃, and the like, and then water leaching is performed, but this also has the problem that the process is complicated and that energy consumption for recovering lithium is large.

Therefore, there is a need for a process that may economically and efficiently recover valuable metals such as cobalt and nickel from the residue including the ternary material from which lithium has been removed, that is, cobalt, nickel, and manganese, by first selectively removing or recovering lithium by a wet process from the waste cathode active material.

### RELATED ART DOCUMENTS

### Patent Document

(Patent Document 1) Korea Patent Publication No. 10-2013-0071838 (published on Jul. 1, 2013)

### SUMMARY OF THE INVENTION

An object of the present invention is to provide a method for selectively recovering lithium from a waste ternary cathode active material, in which high-purity lithium may first be recovered from the waste cathode active material and then valuable metals such as cobalt, nickel, and manganese may be recovered from the residue thereof, and a method of recovering valuable metals such as cobalt (Co), nickel (Ni), and manganese (Mn).

One embodiment of the present invention provides a method of recovering ternary valuable metals from a waste cathode active material, including: a step of leaching valid metals in waste cathode active material powder under acidic conditions; and a step of recovering the leached valid metals, wherein in the step of leaching valid metals in waste cathode active material powder under acidic conditions, an oxidizing agent is further added to selectively leach lithium, the method further comprising: a step of leaching cobalt (Co) and nickel (Ni) from a residue separated from the lithium leachate leached by the step of leaching valid metals in waste cathode active material powder under acidic conditions, and recovering manganese dioxide (MnO₂) as a residue; a step of reducing the residue manganese dioxide; and a step of leaching the manganese dioxide.

The step of reducing the residue manganese dioxide may be performed by a mechanism represented by Scheme 1 below:

### [Scheme 1]

MnO₂→Mn₂O₃→Mn₃O₄→MnO

The step of reducing the residue manganese dioxide may be performed by a method of heat-treating at a temperature of 400 to 600° C.

The step of leaching the manganese dioxide may be performed by using an acid and an additional oxidizing agent.

The additional oxidizing agent may be one or more selected from the group consisting of KMnO₄, Na₂S₂O₈, O₃, and NaClO₃.

After the step of leaching the manganese dioxide, a base may be added to remove impurities including Al and Fe.

One embodiment of the present invention provides a method of recovering ternary valuable metals from a waste cathode active material, including: a step of leaching valid metals in waste cathode active material powder under acidic conditions, and recovering the leached valid metals, wherein in the step of leaching valid metals in waste cathode active material powder under acidic conditions, an oxidizing agent is further added to selectively leachate lithium, and the addition amount of the oxidizing agent is 7.5% to 15% by weight.

The oxidizing agent may be one or more selected from the group consisting of KMnO₄, Na₂S₂O₈, O₃, and NaClO₃.

Manganese in the waste cathode active material may be precipitated in the form of manganese dioxide, and nickel and cobalt may be precipitated in the form of lithium oxide due to the influence of the oxidizing agent.

The step of leaching valid metals in waste cathode active material powder under acidic conditions may be performed by leaching at a temperature of 30 to 90° C.

The step of leaching valid metals in waste cathode active material powder under acidic conditions may be performed by leaching at a pH of 2 to 7.

The step of leaching valid metals in waste cathode active material powder under acidic conditions may be performed by leaching for one to four hours.

The step of leaching valid metals in waste cathode active material powder under acidic conditions may be performed at a liquid-to-solid ratio of 5 to 10.

The method of recovering ternary valuable metals from a waste cathode active material may further include: a step of adding a neutralizing agent to the lithium leachate to precipitate and remove impurities other than lithium, after the step of leaching valid metals in waste cathode active material powder under acidic conditions.

The impurities may include a carbonate ((Co—Ni—Mn)CO₃) or a hydroxide ((Co—Ni—Mn)(OH)₂).

The neutralizing agent may be one or more selected from the group consisting of NaOH, NH₄OH, Na₂CO₃, K₂CO₃, CaO, CaCO₃, MgCO₃, and MgO.

The step of recovering the leached valid metals may include a lithium recovery step in which the lithium leachate is heated and concentrated, and then carbonized to recover lithium carbonate.

In the lithium recovery step in which the lithium leachate is heated and concentrated, and then carbonized to recover lithium carbonate, carbonization may be performed by adding one or more selected from the group consisting of Na₂CO₃, K₂CO₃, CaCO₃, and MgCO₃ in an equivalent weight of 1 to 1.5 based on lithium concentration.

The method of recovering ternary valuable metals from a waste cathode active material may further include a step of recovering valuable metals such as cobalt (Co), nickel (Ni), and manganese (Mn) from a residue separated from a lithium leachate leached by the step of leaching valid metals in waste cathode active material powder under acidic conditions.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows a schematic flowchart of a method of separating and recovering valuable metals from waste cathode active material powder according to the present invention;

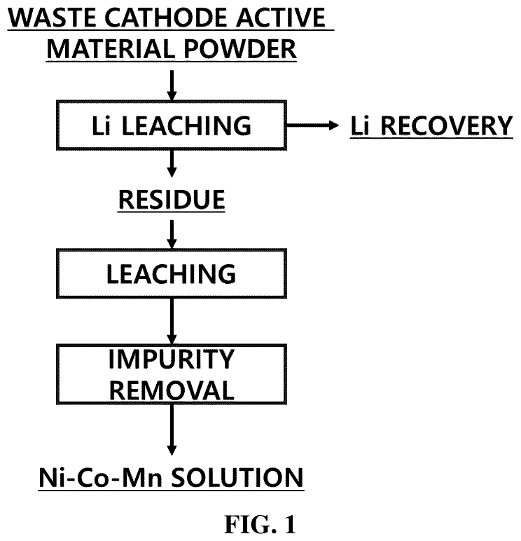

FIG. 2 shows a schematic flowchart of a method for selectively separating and recovering lithium from waste cathode active material powder according to the present invention;

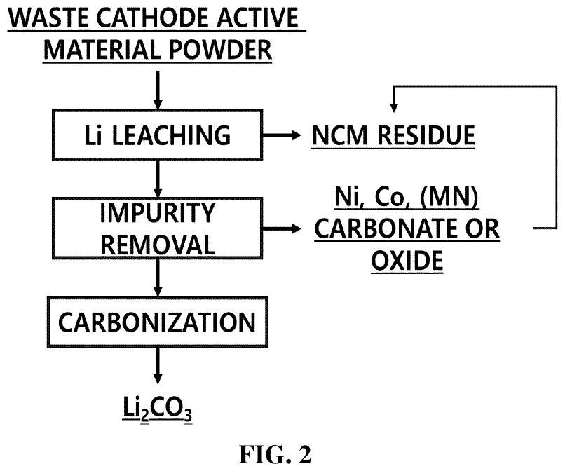

FIG. 3 shows a diagram illustrating the results of an X-ray diffraction (XRD) analysis of waste cathode active material powder used in the present invention;

FIG. 4 shows a diagram illustrating the results of an XRD analysis of a residue after selective leaching of lithium (first leaching); and

FIG. 5 shows a schematic flowchart of a method for separating and recovering valuable metals from waste cathode active material powder.

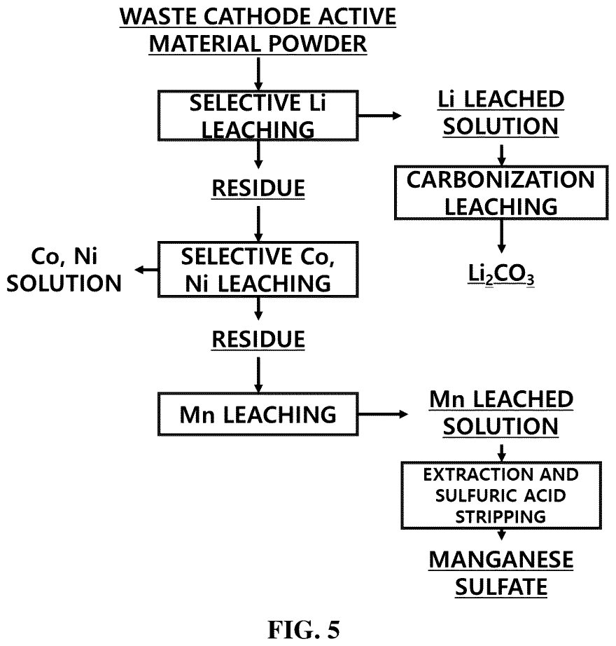

### DETAILED DESCRIPTION OF EXEMPLARY EMBODIMENTS

Hereinafter, the present invention will be described in detail.

The present inventors have discovered that by leaching waste cathode active material powder in an oxidizing agent and then performing a wet process of removing impurities and carbonizing the lithium leaching filtrate, only high-purity lithium may be selectively recovered in advance, and valuable metals such as cobalt, nickel, and manganese may be recovered from the residue from which lithium has been removed, so that high-purity lithium, cobalt, nickel, and manganese valuable metals may be economically and efficiently recovered and thus can be recycled and used again as a cathode active material for a lithium secondary battery, thereby completing the present invention.

The waste cathode active material powder of the present invention is obtained from a lithium secondary battery cathode active material that is found defective during the manufacturing process or discarded, and in particular, a waste Ni—Co—Mn (NCM) ternary cathode active material is used. The collected waste cathode active material is prepared in the form of waste cathode active material powder through a roasting process and a predetermined powdering process. In the waste cathode active material powder, various components such as nickel (Ni), cobalt (Co), manganese (Mn), lithium (Li), and trace amounts of aluminum (Al), copper (Cu), iron (Fe), and calcium (Ca) are mixed.

The method for selectively recovering lithium from a waste cathode active material of the present invention includes a process of selectively recovering only high-purity lithium by performing a wet process of leaching waste cathode active material powder in an oxidizing agent and then removing impurities and carbonizing the lithium leaching filtrate.

Thereafter, when a leaching and impurity-removing process is performed with the residue from which lithium has been removed, valuable metals such as cobalt, nickel, and manganese may also be recovered.

Specifically, the present invention includes: a step of leaching valid metals in waste cathode active material powder under acidic conditions; and recovering the leached valid metals, wherein in the step of leaching valid metals in waste cathode active material powder under acidic conditions, an oxidizing agent is further added to selectively leachate lithium.

First, the step of leaching valid metals in the waste cathode active material powder under acidic conditions is described.

The waste cathode active material powder enables selective dissolution of lithium by causing the crystal lattice of the layered structure to collapse or be transformed by an oxidizing agent.

The oxidizing agent is one or more selected from the group consisting of KMnO₄, Na₂S₂O₈, O₃, and NaClO₃, but it is preferable to perform the reaction under the conditions of optimal addition amount, reaction temperature, pH, reaction time, and liquid-solid ratio using potassium permanganate (KMnO₄).

The addition amount of the oxidizing agent may be 7.5% to 15% by weight. When the above-described range is satisfied, the leaching rate may be controlled to an optimal range. More specifically, it was confirmed that the limit of the addition amount of an oxidizing agent is 15% by weight based on the raw material at the maximum.

The optimal reaction temperature is preferably in the temperature range of 30 to 90° C., and when the reaction temperature is 30° C. or lower, the oxidation reaction of manganese is not active, so the leaching rate of valuable metals such as cobalt and nickel increases, and thus the selectivity for lithium is decreased, and when the reaction temperature is 90° C. or higher, the energy cost consumed for the water evaporation and heating increases, which is not preferable. More specifically, 50 to 80° C. is preferable.

In addition, the optimal pH is preferably in the range of 2 to 10, and when the water leaching pH is 10 or higher, the oxidation reaction rate of manganese is slow, so the leaching rate of lithium is low, and when it is pH 2 or lower, the amount of alkaline agent consumed for neutralization increases, which is not economical. Here, the pH may be adjusted by selecting one or more from the group consisting of H₂SO₄, HCl, and HNO₃. A more preferable pH range may be in the range of 2 to 5.

In addition, the optimal reaction time is preferably in the range of one to four hours, and when it increases to more than 4 hours, the leaching rate is not significantly improved compared to the increase in the operating time, which is not preferable.

In addition, the waste cathode active material powder and the oxidizing agent aqueous solution may have a liquid-solid ratio preferably in the range of 5 to 10, and when the high-liquid ratio (L/S) is 10 or more, the lithium concentration in the leachate decreases, which increases the energy cost required to concentrate the lithium, and when the L/S is 5 or less, the lithium concentration increases to 13 g/L or more, which causes the lithium precipitation reaction to be predominant over the leaching reaction, which significantly slows down the dissolution rate.

After the step of leaching valid metals in waste cathode active material powder under acidic conditions, a neutralizing agent may be added to the lithium leachate to precipitate and remove impurities other than lithium.

To remove impurities (Cu, Al, Ca, etc.) other than lithium from the lithium leachate, an alkaline neutralizing agent may be added, and the neutralizing agent may be one or more selected from the group consisting of NaOH, NH₄OH, Na₂CO₃, K₂CO₃, CaO, CaCO₃, MgCO₃, and MgO, but it is preferable to adjust the pH to a range of 9 to 10 using sodium carbonate (Na₂CO₃).

After neutralization using the neutralizing agent as described above, the obtained precipitate includes cobalt, nickel, manganese, and the like in addition to Cu, Al, and Ca. At this time, the properties of the nickel, cobalt, and manganese precipitates vary depending on the type of the alkaline agent, and they may be mainly obtained as a carbonate ((Co—Ni—Mn)CO₃) or hydroxide ((Co—Ni—Mn)(OH)₂) coprecipitate.

The step of recovering the leached valid metals may include a lithium recovery step in which the lithium leachate is heated and concentrated, and then carbonized to recover lithium carbonate.

The heating and concentrating are performed at a temperature of 50 to 95° C., and may be performed preferably at a temperature of 90° C.

In addition, the carbonation is performed by adding one or more selected from the group consisting of Na₂CO₃, K₂CO₃, CaCO₃, and MgCO₃, and preferably, sodium carbonate (Na₂CO₃) is added at a concentration of 1 to 1.5 mol per 1 mol of lithium to recover lithium carbonate.

Thereafter, to remove the sodium coprecipitated in the lithium carbonate, water washing may be performed twice at a high liquid-solid ratio (lithium carbonate and water; L/S) of 3:1, thereby recovering high-purity lithium.

In addition, the present invention provides a method of recovering ternary valuable metals from a waste cathode active material, including a step of recovering valuable metals of cobalt (Co), nickel (Ni), and manganese (Mn) from a composition including a residue separated from the lithium leachate and/or impurities other than the precipitated lithium.

The step of recovering valuable metals of cobalt (Co), nickel (Ni), and manganese (Mn) may be performed by using any method without limitation as long as it is a method capable of recovering valuable metals of cobalt (Co), nickel (Ni), and manganese (Mn), such as a leaching reaction or an impurity-removing reaction.

More specifically, one embodiment of the present invention provides a method of recovering ternary valuable metals from a waste cathode active material, including: a step of leaching valid metals in waste cathode active material powder under acidic conditions; and a step of recovering the leached valid metals, wherein in the step of leaching valid metals in waste cathode active material powder under acidic conditions, an oxidizing agent is further added to selectively leach lithium, the method further comprising: a step of leaching cobalt (Co) and nickel (Ni) from a residue separated from the lithium leachate leached by the step of leaching valid metals in waste cathode active material powder under acidic conditions, and recovering manganese dioxide (MnO₂) as a residue; a step of reducing the residue manganese dioxide; and a step of leaching the manganese dioxide.

The residue from which lithium has been removed, obtained by filtering the leachate from the lithium leachate, includes MnO₂, LiCoO₂, and LiNiO₂, and the precipitated impurities other than lithium include a carbonate ((Co—Ni—Mn)CO₃) or a hydroxide ((Co—Ni—Mn)(OH)₂) coprecipitate, which is a hydrolysis product of cobalt, nickel, and manganese.

Therefore, the present invention may allow to selectively leach and recover lithium at a high concentration from a waste ternary cathode active material by a wet process, and recover ternary valuable metals other than lithium, that is, nickel, cobalt, manganese, and the like, from the leachate residue from which lithium has been removed, in a simpler and more economical way than the existing process.

Hereinafter, the present invention will be described in more detail through examples. These examples are only intended to explain the present invention more specifically, and it will be obvious to those skilled in the art that the scope of the present invention is not limited by these examples according to the gist of the present invention.

### Example 1

[Table 1] shows an example of the raw material composition of the waste NCM cathode active material used in the experiment.

TABLE 1

| Content | Co | Ni | Mn | Fe | Al; | Ca | Li |
|---|---|---|---|---|---|---|---|
| Wt % | 12.9 | 28.4 | 11.2 | 0.01 | 0.25 | 0.03 | 6.3 |

### Example 1: Lithium Leaching

The reaction for leaching lithium proposed in the present invention is described below.

When potassium permanganate (KMnO₄) is added as an oxidizing agent, as shown in the scheme below, three electrons are obtained from manganese (3-valent) contained in the NCM cathode active material under acidic conditions and converted into a manganese oxide, MnO₂, in a tetravalent state. At this time, the layered crystal lattice of the ternary cathode active material Li(Ni,Co,Mn)O₂ is partially collapsed or deformed, thereby creating an environment in which selective dissolution of lithium is possible.

### [Scheme]

2MnO₄⁻+2H⁺+3Mn₂O₃->8MnO₂(s)+H₂O

(Three electrons consumed per 1 mol of KMnO₄)

(4 mol of MnO₂ produced per 1 mol of KMnO₄)

At this time, some manganese may be dissolved as a side reaction of the above-described reaction, as shown in the side reaction scheme below.

### [Side Reaction Scheme]

MnO₄⁻+8H⁺+5e⁻=Mn²⁺+4H₂O

The reaction variables of the following leaching experiment were optimized by changing the reaction temperature, oxidizing agent concentration, liquid-solid ratio, and the like. Sulfuric acid was used to control pH, and the experiment was conducted under the reaction temperature condition of 70° C., except for the reactions to investigate the effect of the reaction temperature.

### 1-1. Effect of Reaction Temperature

The lithium leaching behavior according to the change in the reaction temperature of the waste NCM cathode active material was investigated.

The evaluation was performed under fixed conditions of liquid-solid ratio (10), reaction pH (2), reaction time (three hours), and amount of oxidizing agent (15% by weight).

With regard to the leaching behavior according to the reaction temperature in Tables 2 and 3 below (leachate composition, unit: mg/L), when the reaction temperature was 25° C., the lithium concentration was 4,449 mg/L, indicating a leaching rate of approximately 77%, but the leaching rates of cobalt, nickel, and manganese also tended to to increase at the same time, and as the temperature increased to 70° C., the leaching rate of lithium improved to 82%, and the leaching rates of manganese and cobalt tended to decrease relatively.

TABLE 2

| Reaction temperature | | | | |
|---|---|---|---|---|
| (° C.) | Co | Ni | Mn | Li |
| 25 | 2,265 | 6,696 | 2,326 | 4,449 |
| 50 | 1,202 | 6,471 | 0.5 | 4,697 |
| 70 | 722 | 9,312 | 0.3 | 5,859 |

(Unit: mg/L)

TABLE 3

| Reaction temperature | | | | |
|---|---|---|---|---|
| (° C.) | Co | Ni | Mn | Li |
| 25 | 17.8 | 23.4 | 20.7 | 78 |
| 50 | 13.3 | 32.4 | 0.0 | 80 |
| 70 | 10.7 | 36.3 | 0.0 | 82.4 |

(Unit: %)

### 1-2. Addition Amount of Oxidizing Agent (KMnO₄)

The lithium leaching behavior according to the addition amount of an oxidizing agent to the aqueous solution using potassium permanganate (KMnO₄) as an oxidizing agent (leachate composition, unit: mg/L) is shown in Tables 4 and 5 below.

The addition amount of the oxidizing agent was evaluated based on 100% by weight of the total aqueous solution. It was confirmed that when the addition amount was 19% by weight, the leaching amount of Ni rather decreased.

As shown in Table 4, it was confirmed that the leaching rates of Co and Ni also decreased.

TABLE 4

| Addition amount | | | | |
|---|---|---|---|---|
| (wt %) | Co | Ni | Mn | Li |
| 7.5 | 2,773 | 12,570 | 0.8 | 4,932 |
| 15 | 722 | 9,312 | 0.3 | 5,859 |
| 19 | 1,194 | 8,035 | 0.5 | 5,490 |

(Unit: mg/L)

TABLE 5

| Addition amount | | | | |
|---|---|---|---|---|
| (wt %) | Co | Ni | Mn | Li |
| 7.5 | 21.8 | 44.0 | 0.0 | 80.4 |
| 15 | 10.7 | 36.3 | 0.0 | 82.4 |
| 19 | 9.4 | 29.3 | 0.0 | 84.2 |

(Leaching rate: %)

### 1-3. Change in Water Leaching pH

The lithium leaching behavior according to the change in the water leaching pH (leachate composition, unit: mg/L) was investigated. When the cathode active material powder was mixed with water, the pH was 11 or higher, indicating that the mixture was alkaline, and sulfuric acid was added to lower the pH to an acidic state. As shown in Tables 5 and 6 below, as the water leaching pH was decreased, that is, as the pH moved into the acidic region, the lithium leaching rate increased, and at pH 2, the lithium leaching rate improved to 82%.

It is generally predicted that the reaction between the oxidizing agent and manganese in the cathode active material will occur in the acidic and alkaline regions as described below, and since the oxidizing power tends to increase as the pH goes into the acidic region, it is considered that the lithium leaching rate improved in the acidic region with excellent oxidizing power.

(Acidic region)MnO₄⁻+4H⁺+3e⁻=MnO₂(s)+2H₂O,E^{O}1.70V

(Alkaline region)MnO₄⁻+2H₂O+3e⁻=MnO₂(s)+₄OH⁻,E^{o}=0.59V

TABLE 6

| pH | Co | Ni | Mn | Li |
|---|---|---|---|---|
| 11 | 3.4 | 1.9 | 0.0 | 1,158 |
| 5 | 0.0 | 1,356 | 0.15 | 3,024 |
| 2 | 722 | 9,312 | 0.3 | 5,859 |

(Unit: mg/L)

TABLE 7

| pH | Co | Ni | Mn | Li |
|---|---|---|---|---|
| 11 | 0.0 | 0.0 | 0.0 | 29.9 |
| 5 | 0.0 | 5.6 | 0.0 | 66.7 |
| 2 | 10.7 | 36.3 | 0.0 | 82.4 |

(Leaching rate: %)

### 1-4. Change in Liquid-Solid Ratio

The lithium leaching behavior (leachate composition, unit: mg/L) according to the change in the liquid-solid ratio (waste NCM and aqueous solution) of water leaching is shown. The reaction was performed under fixed conditions of reaction temperature (70° C.), reaction pH (2), reaction time (three hours), and amount of oxidizing agent (15% by weight).

As the liquid-solid ratio was decreased from 10 to 5, the leaching rate of cobalt decreased from 10% to 5%.

TABLE 8

| Liquid-solid ratio L/S) | Co | Ni | Mn | Li |
|---|---|---|---|---|
| 5 | 1389 | 18,630 | 0.5 | 10,850 |
| 10 | 722 | 9,312 | 0.3 | 5,859 |

(Unit: mg/L)

TABLE 9

| Liquid-solid ratio L/S) | Co | Ni | Mn | Li |
|---|---|---|---|---|
| 5 | 4.8 | 28.7 | 0.0 | 83.4 |
| 10 | 10.7 | 36.3 | 0.0 | 82.4 |

(Leaching rate: %)

Therefore, when lithium was leached from the waste NCM cathode active material using potassium permanganate (KMnO₄) as an oxidizing agent according to Example 1, lithium could be recovered at a lithium leaching rate of 82% or more under the conditions of a reaction temperature of 70° C., an oxidizing agent amount of 15% by weight, pH 2, and a liquid-solid ratio (L/S) of 10, and the leaching rates of other valuable metals, that is, cobalt, nickel, and manganese, were low, confirming that lithium could be selectively recovered. Cobalt, nickel, and the like that were leached together with lithium could be selectively recovered through the neutralization process described below (Example 3).

### Example 2: Residue Analysis

The residue separated through reduced pressure filtration after lithium leaching according to Example 1 was analyzed by X-ray diffraction (XRD).

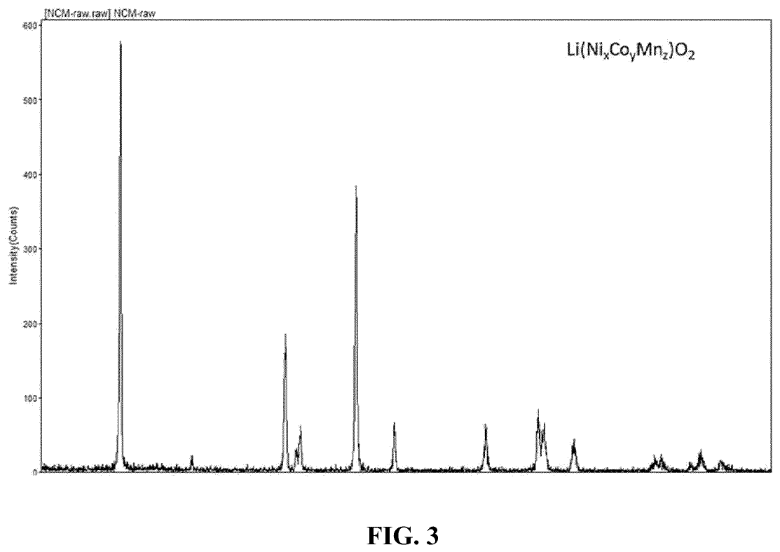

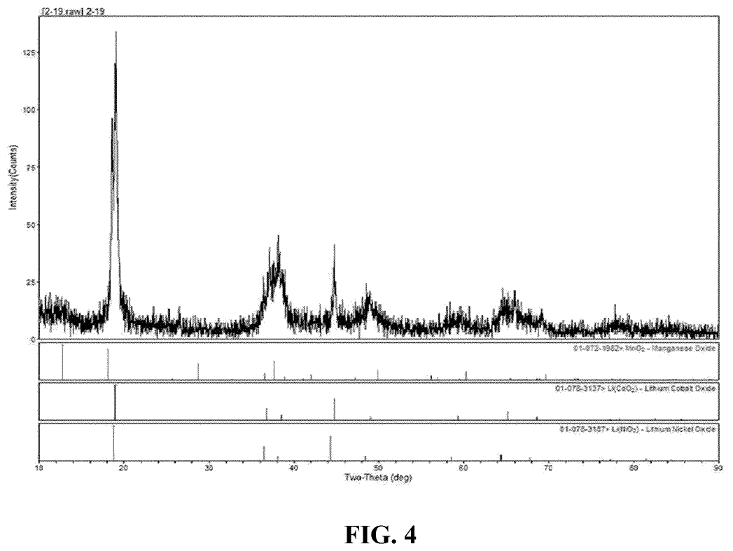

The results of the XRD analysis of the residue recovered after lithium leaching are shown in FIG. 4. Compared to the raw material composition Li(NiₓCo_{y}Mn_{z})O₂ in FIG. 3, the analytical results showed that most of the manganese was converted to manganese dioxide (MnO₂), and cobalt and nickel remained in forms combined with lithium, as LiCoO₂ and LiNiO₂, respectively.

### Example 3: Impurity Removal

As in Example 1, to remove impurities (Co, Ni, Al, etc.) other than lithium in the lithium leachate, 40 g of Na₂CO₃ was added to 1 L of the Li leached solution (pH 2.2) solution to neutralize to a pH range of 9 to 10. After the neutralization, lithium was obtained at 99.9% without loss, and the obtained precipitate was a carbonate including cobalt and nickel contained in the filtrate. The precipitate was treated together with the residue separated after lithium leaching as in Example 2, and valuable metals such as cobalt, nickel, and manganese could be recovered without loss.

TABLE 10
(Unit: mg/L)

| | Co | Ni | Mn | Cu | Ca | Al | Fe | Li | pH |
|---|---|---|---|---|---|---|---|---|---|
| Leached | 972 | 5,328 | 211 | 0.08 | 3.1 | 58.1 | ND | 5,334 | 2.2 |
| solution | | | | | | | | | |
| After | 0.2 | ND | 0.4 | ND | 5 | ND | ND | 5,330 | 9.3 |
| neutralization | | | | | | | | | |

### Example 4: Recovery of Lithium Carbonate

After neutralizing the lithium leached solution as in Example 3, it was heated and concentrated at a temperature of 90° C., and Na₂CO₃ was added up to 1.5 equivalents based on the concentration of lithium to recover lithium carbonate. To remove the coprecipitated sodium in the recovered lithium carbonate, the lithium leachate was washed twice at a liquid-solid ratio (lithium carbonate and water; L/S) of 3:1 at 90° C., and then lithium carbonate with a purity of 98.4% was recovered.

TABLE 11

| | Co | Ni | Mn | Cu | Ca | Al | Fe | Na | Li |
|---|---|---|---|---|---|---|---|---|---|
| Component in | ND | ND | 1.7 | ND | 86 | ND | ND | 8,060 | 184,800 |
| lithium | | | | | | | | | |
| carbonate | | | | | | | | | |
| (mg/kg) | | | | | | | | | |

The present invention may allow to selectively leach and recover lithium at a high concentration from a waste ternary cathode active material by a wet process, and recover ternary valuable metals other than lithium, that is, nickel, cobalt, manganese, and the like, from the leachate residue from which lithium has been removed, in a simpler and more economical way than the existing process.

### Example 5

### Raw Material Composition

The raw material used in the process was obtained by purchasing a large amount of a ternary cathode active material of NCM composition used in electric vehicle batteries and then homogenizing it before use.

Representative samples were collected and decomposed, and the chemical composition of the raw material analyzed by inductively coupled plasma-atomic emission spectroscopy (ICP-OES) exhibited an NCM 622 composition of 10.4% cobalt (Co), 34.1% nickel (Ni), 7.3% manganese (Mn), and 6.9% lithium (Li), and it was confirmed that as major impurities, aluminum (Al) and iron (Fe) were present in an amount less than 1%.

TABLE 12

| Content | Co | Ni | Mn | Fe | Al | Ca | Li |
|---|---|---|---|---|---|---|---|
| Wt % | 10.4 | 34.1 | 7.3 | 0.03 | 0.04 | 0.19 | 6.9 |

### Li Leaching and Valuable Metal Leaching

An experiment was conducted in a matter similar to the above-described method of Example 1. Specifically, to leach lithium, cobalt, nickel, and manganese were minimized and only lithium was first selectively leached under the conditions of a liquid-solid ratio of 10, a reaction temperature of 70° C., a reaction time of three hours, pH 2, and a KMnO₄ amount of 15% by weight.

Here, valuable metals including cobalt and nickel other than lithium were neutralized and removed using CaO or NaOH, and lithium carbonate synthesis was performed after removing impurities when necessary.

An experiment was performed to leach valuable metals from the residue from which lithium was first selectively leached from the NCM waste battery scrap.

The experimental conditions were a reducing agent addition amount of 30% by weight, pH 0.5, reaction temperature 90° C., a liquid-solid ratio of 15, and a reaction time of eight hours, and 95% sulfuric acid was added as a leaching agent for leaching.

As shown in the table below, when a total reaction time of eight hours had elapsed, the analytical results confirmed that the leaching rate of nickel was 97.4%, the leaching rate of cobalt was 90.3%, and the leaching rate of lithium was 97.8%.

TABLE 13
Analytical results

| | First leaching residue | Second leaching | Leaching |
|---|---|---|---|
| Element | (mg/kg) | residue (mg/kg) | rate (%) |
| Co | 99,963 | 29,283 | 90.3 |
| Ni | 254,253 | 19,209 | 97.4 |
| Li | 14,613 | 1,083 | 97.8 |

### Recovery of High-Purity Manganese Compounds

After cobalt-nickel leaching, the residue was in the form of MnO₂, and leaching was difficult due to the strong binding force of MnO₂, so leaching were performed after reduction.

### [Scheme 1]

MnO₂→Mn₂O₃→Mn₃O₄→MnO

After heat treatment at 550° C. for one hour to reduce MnO₂, a leaching experiment was performed.

The experimental conditions were the reaction time of two hours at room temperature, a liquid-solid ratio of 20, and a pH adjusted to 1.5 with 95% sulfuric acid, and hydrogen peroxide was added as an oxidizing agent to perform the experiment.

As can be seen in the table below, the manganese leaching rate was confirmed to be 82.4%.

TABLE 14

| | Al | Ca | Co | Fe | K | Li | Mg | Mn | Na | Ni |
|---|---|---|---|---|---|---|---|---|---|---|
| Residue | 5,241 | N.D. | 112,668 | 308.6 | 9,034 | 4,020 | 29.8 | 315,523 | 8,594 | 214,509 |
| after heat | | | | | | | | | | |
| treatment | | | | | | | | | | |
| (mg/kg) | | | | | | | | | | |
| Leaching | — | — | — | — | — | — | — | 82.4 | — | — |
| rate (%) | | | | | | | | | | |

(N.D.: Not Detected)

### Removal of Impurities in Manganese Solvent Extraction Process

To remove Al and Fe in the manganese leachate, 25% NaOH was added to increase the pH to 6.0.

The table below shows the composition of the manganese leachate after removing impurities.

TABLE 15

| Al | Ca | Co | Cu | Fe | K | Li | Mg | Mn | Na | Ni |
|---|---|---|---|---|---|---|---|---|---|---|
| 1.2 | N.D. | 1,627 | 0.6 | 0.3 | 442.8 | 155.6 | 0.7 | 11,143 | 16,776 | 1,191 |

(N.D.: Not Detected)

### Extraction

Two-stage extraction was performed under the conditions of 25% di-(2-ethylhexyl) phosphoric acid (D2EHPA) as an extracting agent, 50% saponification, and O/A=1, and the manganese concentration and equilibrium pH of the water phase after the extraction are as shown in the table below.

Finally, it was confirmed that the two-stage extraction rate of manganese was 99.9%.

TABLE 16

| | Mn (mg/L) | Equilibrium pH |
|---|---|---|
| Manganese leachate after removing | 11,143 | 6.1 |
| impurities | | |
| First-stage AQ. | 583.9 | 4.5 |
| Second-stage AQ. | 11.6 | 5.0 |

In addition, the metal composition analyzed by mixing the first-stage and second-stage extracted organic phases is shown in the table below.

TABLE 17

| Al | Ca | Co | Cu | Fe | K | Li | Mg | Mn | Na | Ni |
|---|---|---|---|---|---|---|---|---|---|---|
| 2.2 | 8.4 | 729.5 | 0.5 | 6.7 | 55.8 | 32.1 | 1.1 | 4,644 | 3,701 | 494.7 |

### Stripping (Recovery of Manganese Sulfate)

First-stage stripping was performed under the condition of O/A=10, and the stripping rate and manganese purity were confirmed using 1.2 M sulfuric acid as a stripping solution.

The manganese stripping rate was 28.5%, and the manganese sulfate purity was 96.8%. The stripping rate was calculated as the manganese concentration in the stripping solution/(manganese concentration in the organic phase after extraction×O/A)×100 (%).

The purity of manganese sulfate was calculated as 100−(total impurities in the solution %).

TABLE 18

| Al | Ca | Co | Cu | Fe | K | Li | Mg | Mn | Na | Ni |
|---|---|---|---|---|---|---|---|---|---|---|
| 3.8 | 17.5 | 4,603 | 1.5 | 2.7 | 297.4 | 181.0 | 4.0 | 13,216 | 23,782 | 3,174 |

Through the method for selectively recovering lithium from a ternary (nickel (Ni)-cobalt (Co)-manganese (Mn); NCM) waste cathode active material according to the present invention, high-purity lithium can be obtained with a low lithium loss rate by first performing a step of selectively recovering high-purity lithium through a leaching process of the waste cathode active material.

In addition, valuable metals such as cobalt, nickel, and manganese can be recovered from the residue from which lithium has been removed, obtained through the lithium recovery process, so that not only lithium (Li) but also valuable metals such as cobalt (Co), nickel (Ni), and manganese (Mn) can be recovered economically and efficiently.

The present invention is not limited to the above examples, but may be manufactured in various different forms, and a person having ordinary skill in the art to which the present invention pertains will understand that the present invention may be implemented in other specific forms without changing the technical idea or essential features of the present invention. Therefore, it should be understood that the above-described examples are illustrative in all respects and not restrictive.

What is claimed is:

1. A method of recovering ternary valuable metals from a waste cathode active material, comprising:
a step of leaching valid metals in waste cathode active material powder under acidic conditions; and
a step of recovering the leached valid metals,
wherein in the step of leaching valid metals in waste cathode active material powder under acidic conditions, an oxidizing agent is further added to selectively leach lithium,
the method further comprising:
a step of leaching cobalt (Co) and nickel (Ni) from a residue separated from the lithium leachate leached by the step of leaching valid metals in waste cathode active material powder under acidic conditions, and recovering manganese dioxide (MnO₂) as a residue;
a step of reducing the residue manganese dioxide; and
a step of leaching the manganese dioxide.

2. The method of recovering ternary valuable metals from a waste cathode active material according to claim 1, wherein the step of reducing the residue manganese dioxide is performed by a mechanism represented by Scheme 1 below:
[Scheme 1]
MnO₂→Mn₂O₃→Mn₃O₄→MnO

3. The method of recovering ternary valuable metals from a waste cathode active material according to claim 2, wherein the step of reducing the residue manganese dioxide is performed by a method of heat-treating at a temperature of 400 to 600° C.

4. The method of recovering ternary valuable metals from a waste cathode active material according to claim 1, wherein the step of leaching the manganese dioxide is performed by using an acid and an additional oxidizing agent.

5. The method of recovering ternary valuable metals from a waste cathode active material according to claim 4, wherein the additional oxidizing agent is one or more selected from the group consisting of KMnO₄, Na₂S₂O₈, O₃, and NaClO₃.

6. The method of recovering ternary valuable metals from a waste cathode active material according to claim 4, wherein, after the step of leaching the manganese dioxide, a base is added to remove impurities including Al and Fe.

7. The method of recovering ternary valuable metals from a waste cathode active material according to claim 1, wherein the addition amount of the oxidizing agent is 7.5% to 15% by weight.

8. The method of recovering ternary valuable metals from a waste cathode active material according to claim 1, wherein the oxidizing agent is one or more selected from the group consisting of KMnO₄, Na₂S₂O₈, O₃, and NaClO₃.

9. The method of recovering ternary valuable metals from a waste cathode active material according to claim 1, wherein manganese in the waste cathode active material is precipitated in the form of manganese dioxide, and nickel and cobalt are precipitated in the form of lithium oxide due to the influence of the oxidizing agent.

10. The method of recovering ternary valuable metals from a waste cathode active material according to claim 1, wherein the step of leaching valid metals in waste cathode active material powder under acidic conditions is performed by leaching at a temperature of 30 to 90° C.

11. The method of recovering ternary valuable metals from a waste cathode active material according to claim 1, wherein the step of leaching valid metals in waste cathode active material powder under acidic conditions is performed by leaching at a pH of 2 to 7.

12. The method of recovering ternary valuable metals from a waste cathode active material according to claim 1, wherein the step of leaching valid metals in waste cathode active material powder under acidic conditions is performed by leaching for one to four hours.

13. The method of recovering ternary valuable metals from a waste cathode active material according to claim 1, wherein the step of leaching valid metals in waste cathode active material powder under acidic conditions is performed at a liquid-to-solid ratio of 5 to 10.

14. The method of selectively recovering lithium according to claim 1, further comprising: a step of adding a neutralizing agent to the lithium leachate to precipitate and remove impurities other than lithium, after the step of leaching valid metals in waste cathode active material powder under acidic conditions.

15. The method of recovering ternary valuable metals from a waste cathode active material according to claim 14, wherein the neutralizing agent is one or more selected from the group consisting of NaOH, NH₄OH, Na₂CO₃, K₂CO₃, CaO, CaCO₃, MgCO₃, and MgO.

16. The method of recovering ternary valuable metals from a waste cathode active material according to claim 1, wherein the step of recovering the leached valid metals includes a lithium recovery step in which the lithium leachate is heated and concentrated, and then carbonized to recover lithium carbonate.

17. The method of recovering ternary valuable metals from a waste cathode active material according to claim 16, wherein, in the lithium recovery step in which the lithium leachate is heated and concentrated, and then carbonized to recover lithium carbonate, carbonization is performed by adding one or more selected from the group consisting of Na₂CO₃, K₂CO₃, CaCO₃, and MgCO₃ in an equivalent weight of 1 to 1.5 based on lithium concentration.
